(19) United States
(12) Patent Application Publication
(10) Pub. No.: US 2021/0097102 A1
(43) Pub. Date: Apr. 1, 2021

(54) QUERYING IMAGES FOR DISCRETE PATTERNS USING REGULAR EXPRESSIONS

(71) Applicant: Hewlett-Packard Development Company, L.P., Spring, TX (US)

(72) Inventor: Nathan Moroney, Palo Alto, CA (US)

(73) Assignee: Hewlett-Packard Development Company, L.P., Spring, TX (US)

(21) Appl. No.: 16/970,651

(22) PCT Filed: Apr. 19, 2018
(86) PCT No.: PCT/US2018/028381

§ 371 Date: Aug. 18, 2020

(51) Int. Cl. G06F 16/54; G06F 16/538; G06F 16/532

(52) U.S. Cl. CPC G06F 16/54; G06F 16/532; G06F 16/538

(57) ABSTRACT

In an example method, an image to be queried is received. An image representation including symbols is generated from the image via a classifier. A query is received and a target regular expression is generated based on the query. The image representation is queried for a discrete pattern using the target regular expression.

### BACKGROUND

Regular expressions are used to define search patterns. For example, a search pattern may be a sequence of characters and may be used by string searching algorithms to perform find or find and replace operations on strings.

### BRIEF DESCRIPTION OF THE DRAWINGS

Various features of the techniques of the present application will become apparent from the following description of examples, given by way of example only, which is made with reference to the accompanying drawings, of which:

FIG. 1 is a schematic diagram of an example system for querying images for discrete patterns using a target regular expression;

FIG. 2 is a drawing of an example image representation using symbols;

FIG. 3 is a drawing of an example highlighted discrete edge pattern of edge regions in an example image representation;

FIG. 4 is a process flow diagram illustrating an example method for querying images for discrete patterns using a target regular expression;

FIG. 5A is block diagram of an example computing device to query images for discrete patterns using regular expressions;

FIG. 5B is block diagram of another example computing device to query images for discrete patterns using regular expressions; and

FIG. 6 is a drawing of an example machine-readable storage medium that may be used to query images for discrete patterns using regular expressions.

### DETAILED DESCRIPTION

In imaging applications, a manual query may be used with a menu adjustment that enables a user to manually select pixels of interest in an image. Specifically, a selection tool can be used to manually select a specific pixel or voxel of interest whose color is then used in combination with a menu to define a region tolerance to query neighboring pixels or voxels. However, manual selection of regions is limited to single connected regions of colors, and may require manual steps to identify the target color. Nor does manual selection provide support for more complex queries. Alternatively, system instructions may be written to perform fixed predefine queries. The system instructions may include reading pixel or voxel data and the application of customized application logic and the returning of any locations matching the explicitly defined application logic. Customized application logic may be written to include keeping track of previous N pixel or voxel RGB values. However, such techniques may not be able to define a system to logically identify a given pattern, such as finding pixels of voxels that are close to RGB values 255,0,0 of at least 3 consecutive pixels or voxels, that can be used directly to perform another pattern search, such as find a pixel or voxel with RGB value close to 0,255,0 next to a pixel or voxel close to 0,0,255, or ranges of pixels or voxels. In addition, such techniques may not be able to perform both fixed and dynamic queries of pixels or voxel colors.

Techniques are described herein for querying images for discrete patterns using regular expressions. As used herein, a regular expression refers to a sequence of characters or symbols that defines a search pattern. For example, the search pattern may be used by string searching algorithms for “find” or “find and replace” operations on strings. A string, as used herein, refers to a sequence of fixed bit-length sequences holding symbols, such as alphanumeric text. An image representation may be generated based on a received image to be queried. The image representation may include symbols, such as alphanumeric characters or other symbols. A query may be received and a target regular expression generated based on the received query. The image representation may be queried for discrete patterns using the target regular expression. Accordingly, the techniques described herein may be used to detect various types of discrete patterns without having to write additional code or assemble a customized system for detecting each different pattern. The techniques may be used to detect a variety of discrete patterns and may be used to perform edge detection, regional selection, among other types of color patterns. Moreover, the techniques support both static and dynamic types of queries. The techniques may also be implemented using existing languages with regular expression engines or regular expression libraries.

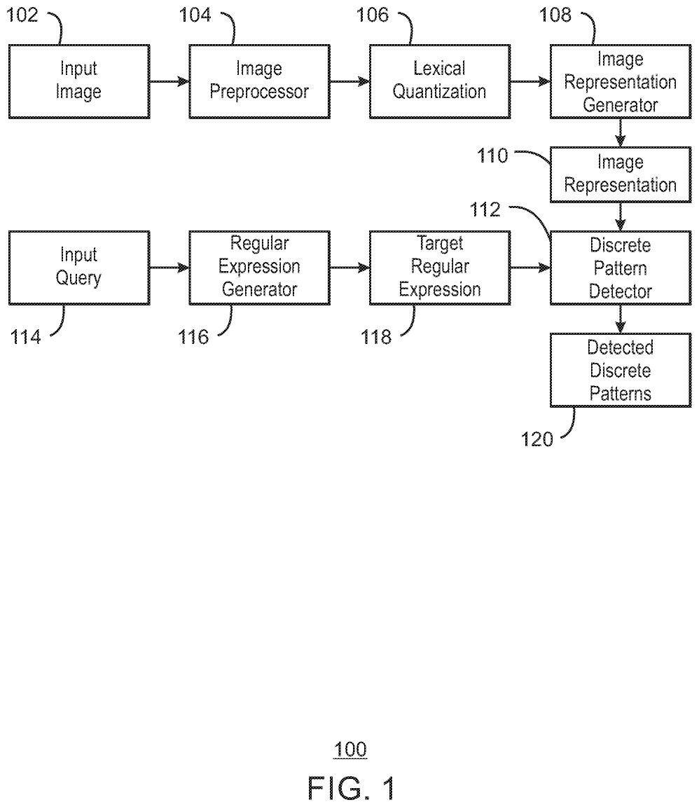

FIG. 1 is a schematic diagram of an example system for querying images for discrete patterns using a target regular expression. The example system is generally referred to by the reference number 100.

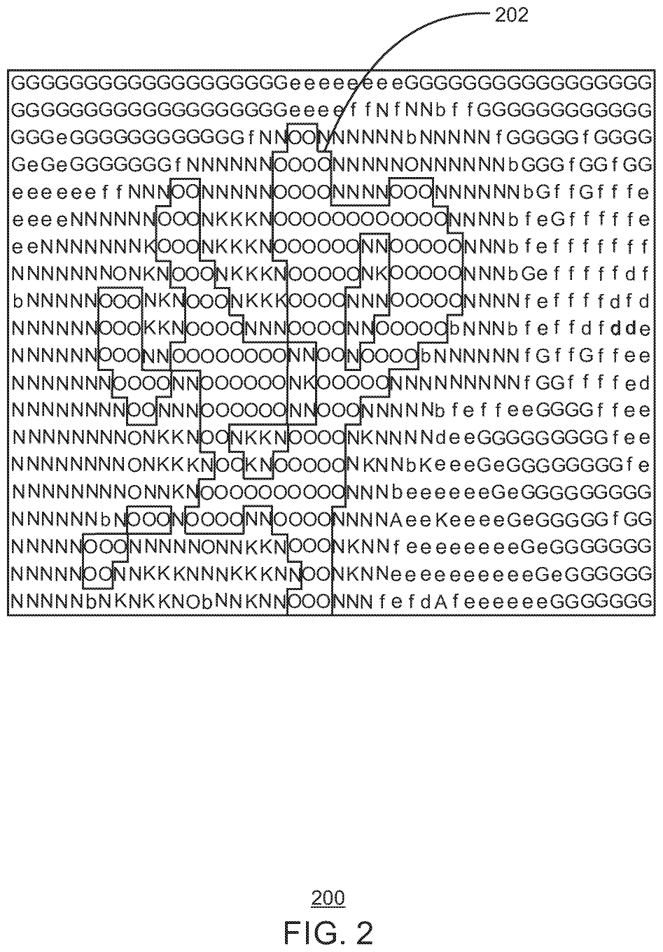

The system 100 includes an input image 102 being received at an image preprocessor 104. The input image 102 may be a color image to be queried for discrete patterns. The image preprocessor 104 may process the color image. For example, the image preprocessor 104 may reduce a number of total colors in the received image. The image preprocessor 104 may also scale down the image and reduce the resolution of received images. The image preprocessor 104 is shown generating a lexical quantization 106 that is shown being sent to the image representation generator 108. The image representation generator 108 may generate image representations based on received lexical quantizations 106. As described in greater detail with respect to FIG. 2, an image representation is a simplified image represented using symbols. The image preprocessor 104 is thus communicatively coupled to the image representation generator 108. The image representation generator 108 is shown generating an image representation 110 that is transmitted to the discrete pattern detector 112. The discrete pattern detector 112 may generate detected discrete patterns based on received target regular expressions 118 and the image representations 110. The image representation generator 108 is communicatively coupled to the discrete pattern detector 112. The system 100 includes an input query 114 shown being received by the regular expression generator 116. The regular expression generator 116 may generate a target regular expressions 118 based on the input queries 114. The regular expression generator 116 is shown generating a target regular expression 118 that is sent to the discrete pattern detector 112. The regular expression generator 116 is therefore also communicatively coupled to the discrete pattern detector 112. The discrete pattern detector 112 is shown generating a set of detected discrete patterns. For example, the discrete patterns may be block of colors, pairs of colors, edges, among others.

In the example system 100, an input query 114 may be used to query an input image 102 for one or more discrete patterns. The system 100 may be used to perform edge detection, region selection, or runs of colors, among other discrete pattern detections. In some examples, the input image 102 may be a two dimensional or a three dimensional image. A two dimensional image may include a number of pixels. A three dimensional image may be composed of three dimensional pixels, referred to herein as voxels. In some examples, the pixels or voxels may be in the form of an image or any other representation in memory. The image preprocessor 104 may generate a lexical quantization 106 based on the input image 102. The lexical quantization 106 may be a color image with a reduced number of colors. For example, the lexical quantization 106 may have 17 color regions, with their primary locations or regions, as compared with millions of colors in the input image 102. The image representation generator 108 may generate an image representation 110 based on the lexical quantization 106. Each of any number of colors in the lexical quantization 106 may be replaced with a single character as shown in the example image representation described in FIG. 2 below. For example, the color green may be replaced with “G” and the color orange may be replaced with “0”, etc. In addition to being color coded using characters, the image representation may be downscaled and cropped. The image representation may also have a distorted aspect ratio. In some examples, the image representation generator 108 may be any type of classifier. The image representation generator 108 may be a pretrained neural network. The image representation generator 108 may alternatively be a look-up table that includes RGB values or colors mapped to particular symbols.

An input query 114 may include a precise request for a discrete pattern. The input query 114 may include one or more colors and a particular type of pattern formed by the colors. The pattern may be a block of colors, an edge between two or more colors, etc. In some examples, the input query 114 may be a predefined static query. For example, a stop sign may be identified using predefined red/white bordering colors. Thus, in applications where stop signs are to be detected, a predefined query of red/white edges may be used. However, the input query 114 may also be dynamically defined. For example, in a 3D printing application, a set of voxels may be queried to identify voxels that are to be 3D printed in black for additional processing. The additional processing may include changing ink levels, Gray Component Replacement (GCR), etc. Black (K) voxels may be dynamically queried based on a dynamically input threshold size.

The regular expression generator 116 may generate a target regular expression 118 based on the input query 114. In some examples, the target regular expression 118 may be any text string that may be translated to a finite state machine or graph that may be dynamically applied to an image representation to detect discrete patterns. The target regular expression 118 may be generated using a regular expression library. For example, for the programming language C++, regular expression libraries that can be used may include RE2, boost or the C++ Standard Library, depending on any implementation requirements for the regular expression processing. RE2 is software library for regular expressions that uses a finite-state machine using automata theory. Boost is a set of libraries for C++ that provide support for tasks and structures including regular expressions. The C++ Standard Library is a collection of classes and functions, which are written in the core language and part of the C++ ISO Standard itself.

The discrete pattern detector 112 may receive the target regular expression 118 and the image representation 110 as inputs, and output detected discrete patterns. The detected discrete patterns may be represented as image highlighted portions of an image representation. In some examples, the detected discrete patterns may be represented using offsets or index values.

The block diagram of FIG. 1 is not intended to indicate that the example system 100 is to include all of the components shown in FIG. 1. Further, the system 100 may include any number of additional components not shown in FIG. 1, depending on the details of the specific implementation. In some examples, additional analysis may be performed on the detected discrete patterns. The system 100 may perform optional post-processing of the regions of detected discrete patterns. Additional patterns within the detected discrete patterns may be queried and returned. The additional patterns may be used to filter out portions of the detected discrete patterns. For example, if the detected discrete patterns are used to detect objects, the portions may be false positives for that may be filtered out based on additional criteria included in additional queries. In the case of voxels, as one example, voxels with a specific size below a threshold size in any dimension may be removed from a set of voxels having certain run characteristics. More detailed analysis may thus be performed using additional queries and dimensions.

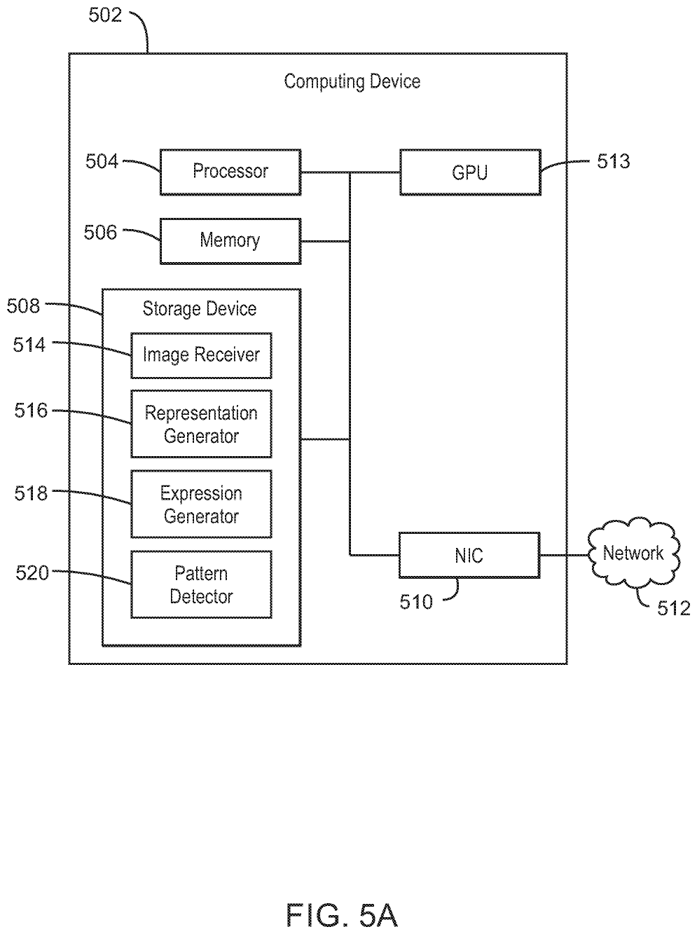

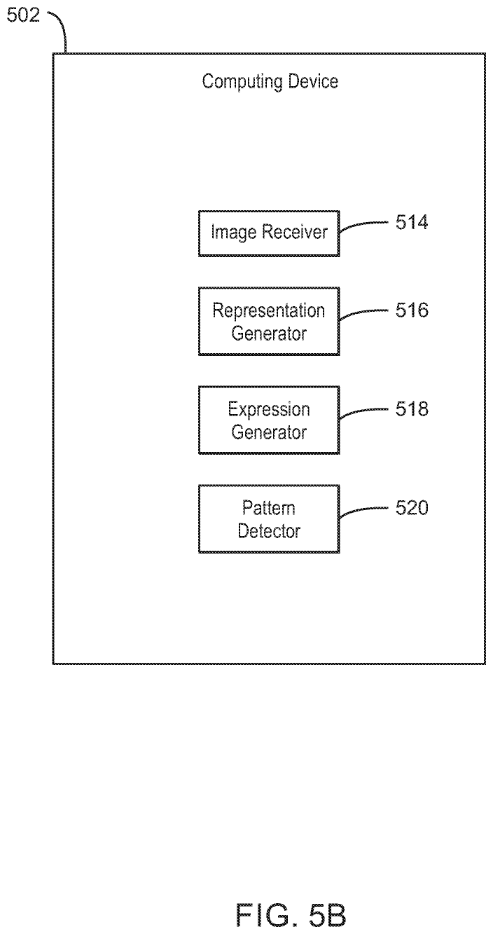

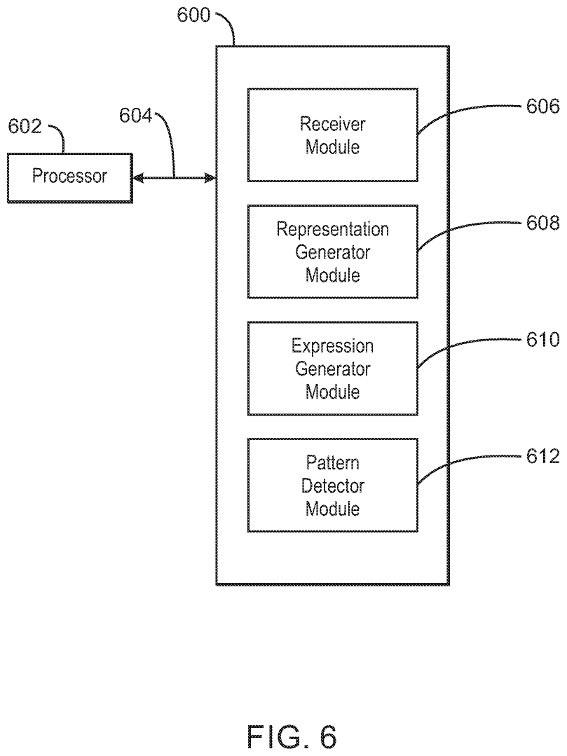

FIG. 2 is a drawing of an example image representation using symbols. The image representation 200 of FIG. 2 may be generated using the system 100 of FIG. 1 above or the computing device 502 of FIG. 5 or the computer readable media 600 of FIG. 6 below.

As shown in FIG. 2, the image representation 200 includes a number of characters 202. For example, the character G may represent one or a region of green pixels, the character O may represent a region of orange pixels, the character b may represent beige pixels, the character N may represent a region of brown pixels, the character K may represent a region of black pixels, the character e may represent a region of dark green pixels, the character f may represent a region of olive pixels, the character d may represent a region of gray pixels, and the character A may represent a region of gray pixels. As used herein, a region is a collection of symbols of one color that share a side. For example, four-connected regions of the same symbol would share top, bottom, left & right; while eight-connected regions would share N, NW, W, SW, S, SE, E, NE symbols using the compass directions North (N), South (S), East (E), West (W). In some examples, the specific properties of a region, such as size, that may be selected can be determined by a regular expression. As can be seen from the overall pattern, the original corresponding input image is a butterfly. Although the aspect ratio is vertically skewed, the image representation 200 still resembles the butterfly of the original input image.

The highlighted discrete consecutive pattern includes highlighted consecutive character regions 202 including at least two consecutive characters corresponding to the color orange. The pattern may have been detected using the regular expression: [O]{2,}, wherein the first brackets include a color to be detected and the second brackets include the number of blocks of the color that may be consecutively grouped in order to be detected. For example, a block may correspond to one or more pixels. In the example of FIG. 2, the color is orange as represented by the character “0” and the number of consecutive blocks of orange to be detected is at least two.

The drawing of FIG. 2 is not intended to indicate that the example image representation 200 is to include all of the components shown in FIG. 2. Further, the image representation 200 may include any number of additional components not shown in FIG. 2, depending on the details of the specific implementation. In some examples, any combination of other symbols or characters may be used to represent any number of colors. Additional symbols or may be used to represent an image containing more than 52 colors. In addition, a second image representation may similarly generated from the original input image after rotating the image by 90 degrees as discussed below, to enable textual analysis of vertical neighbors.

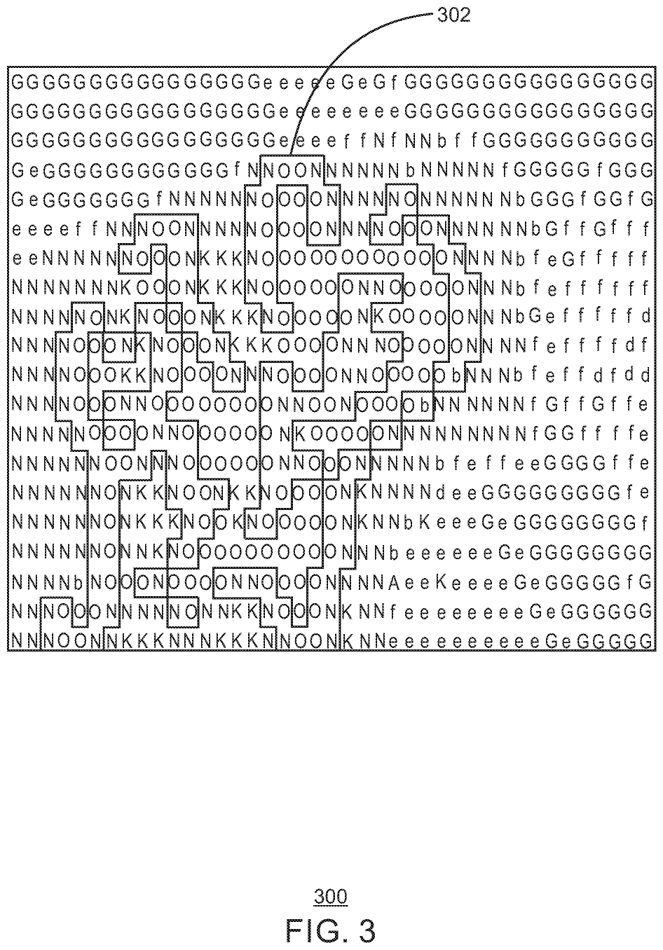

FIG. 3 is a drawing of an example highlighted discrete edge pattern of edge regions in an example image representation. The discrete edge pattern 300 of FIG. 3 may be generated using the system 100 of FIG. 1 above or the computing device 502 of FIG. 5 or the computer readable media 600 of FIG. 6 below.

The example image representation of FIG. 3 may be the same image representation of FIG. 2 above queried for a different pattern. As shown in FIG. 3, the discrete edge pattern 300 includes highlighted regions 302 corresponding to orange and beige/brown edges. The pattern may have been detected using the regular expression: (O)(N|b)|(N|b)(O), wherein the first two sets of parentheses indicate edge colors to be detected and the second two parentheses include the same edge colors grouped in reverse order. In the example of FIG. 3, the color is orange as represented by the character “O,” the color brown is represented by the character N, and the color beige is represented by the character “b.” The regular expression thus selects and highlights edges of orange and brown, orange and beige, brown and orange, and beige and orange edges.

The drawing of FIG. 3 is not intended to indicate that the example discrete edge pattern 300 is to include all of the components shown in FIG. 3. Further, the discrete edge pattern 300 may include any number of additional components not shown in FIG. 3, depending on the details of the specific implementation. In some examples, any combination of other symbols or characters may be used to represent any number of colors. Additional symbols or may be used to represent an image containing more than 52 colors.

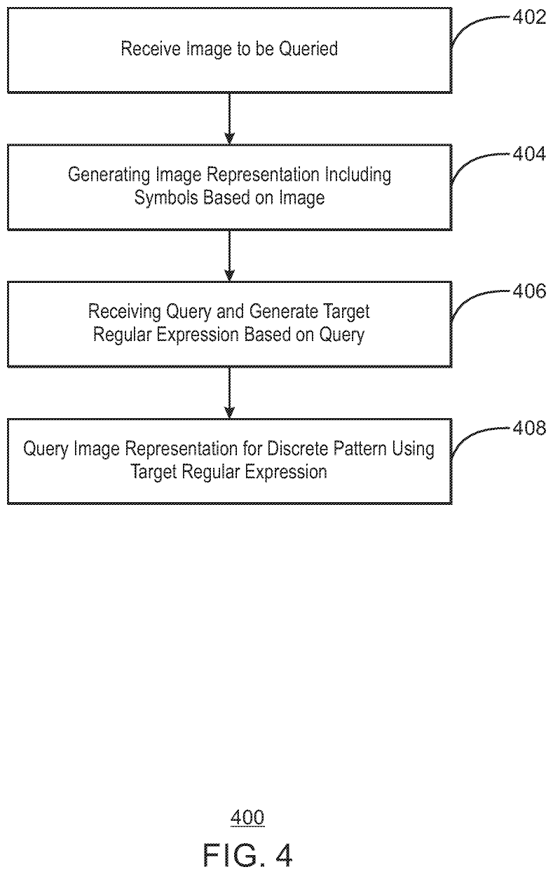

FIG. 4 is a process flow diagram illustrating an example method for querying images for discrete patterns using a target regular expression. The method 400 of FIG. 4 may be implemented in the system 100 of FIG. 1 above or the computing device 502 of FIG. 5 or the computer readable media 600 of FIG. 6 below. For example, the method may be implemented using processor 504 of the computing device 502 or the processor 602 of FIG. 6.

At block 402, an image to be queried is received. The image may be a two dimensional or three dimensional image, including pixels or voxels, respectively. In some examples, the image may be any form of a collection of pixels or voxels.

At block 404, an image representation including symbols is generated from the image. The symbols may be alphanumeric characters representing colors of pixels or of groups or regions of pixels, among other possible symbols. A lexical quantization may be generated based on the image, and the image representation may be generated based on the lexical quantization. For example, the lexical quantization may include a reduced number of colors represented as pixels. The image representation may include a reduced number of colors represented as symbols. For example, the symbols may be used for analysis by a regular expression library.

At diamond 406, a query is received and a target regular expression is generated based on query. The received query may be a static query or a dynamic query. A static query may be used in a system with fixed requirements. For example, the fixed requirements may be to find possible stop sign or regions that are mostly red with some white. A system with variable requirements may use dynamic queries. For example, a catalog system may include users with individual preferences. Such a preference may include finding black and light gray striped fabrics in one example.

At block 408, the image representation is queried for a discrete pattern using the target regular expression. For example, match regions in the image representation may be located as offsets or index values. The offsets or index values may be returned as a result. An image representation with highlighted regions of interest may be returned, as shown in the examples of FIGS. 3A and 3B above. Thus, a visualization or display of match regions resulting from the query may be generated.

It is to be understood that the process diagram of FIG. 4 is not intended to indicate that all of the elements of the method 400 are to be included in every case. Further, any number of additional elements not shown in FIG. 4 may be included in the method 400, depending on the details of the specific implementation. For example, the lexical quantization may be rotated by 90 degrees and a second image representation may be generated for vertical neighbors based on the rotated lexical quantization. The second image representation may be generated by rotating the input image and generating the lexical quantization from the rotated image. The second image representation may then be generated based on the lexical quantization of the rotated image. The second image representation may also be queried using the target regular expression, and a union of the query of the image representation and the second image representation may be returned as a result.

FIG. 5A is a block diagram of an example computing device 502 to query images for discrete patterns using regular expressions. For example, the computing device 502 may be a desktop computer, a server, or a printer, among other computing devices. The computing device 502 may include a processor 504, memory 506, a machine-readable storage 508, and a network interface 510 to connect computing system 502 to network 512. The network interface 510 may be a network interface card (NIC).

The processor 504 may be a main processor that is adapted to execute the stored instructions. Moreover, more than one processor 504 may be employed. Further, the processor 504 may be a single core processor, a multi-core processor, a computing cluster, or any number of other configurations. The processor 504 may be implemented as Complex Instruction Set Computer (CISC) or Reduced Instruction Set Computer (RISC) processors, x86 Instruction set compatible processors, ARMv7 Instruction set compatible processors, multi-core, or any other microprocessor or central processing unit (CPU).

The memory 106 may be one or more memory devices. The memory 106 may be volatile memory or nonvolatile memory. In some examples, the memory 506 may include random access memory (RAM), cache, read only memory (ROM), flash memory, and other memory systems.

The storage 508 is machine-readable storage and may include volatile and nonvolatile memory. The machine-readable storage 508 may be electronic, magnetic, optical, or other physical storage device that stores executable instructions (e.g., code, logic). Thus, the machine-readable storage 508 medium may be, for example, RAM, an Electrically-Erasable Programmable Read-Only Memory (EEPROM), a storage drive such as a hard drive or solid state drive (SSD), an optical disc, and the like. The storage 508 may also include storage or memory external to the computing device 502. Moreover, as described below, the machine-readable storage medium 508 may be encoded with executable instructions (e.g., executed by the one or more processors 504) for prioritizing data. For example, the machine-readable storage medium 508 may be encoded with executable instructions for querying images for discrete patterns using regular expressions.

In some examples, a network interface 510 (e.g., a network interface card or NIC) may couple the computing system 502 to a network 512. The network interface 510 may connect computing system 502 to a local network 512, a virtual private network (VPN), or the Internet. The network interface 510 may include an Ethernet controller.

The computing device 502 may also include a graphics processing unit (GPU) 513. As shown, the processor 504 may be coupled through a bus to the GPU 513. The GPU 513 may be configured to perform any number of graphics operations within the computing device 100. For example, the GPU 513 may be configured to render or manipulate graphics images, graphics frames, videos, or the like, to be displayed to a user of the computing device 502.

The storage device 508 may include an image receiver 514, a representation generator 516, an expression generator 518, and a pattern detector 520. The image receiver 514 may receive an image to be queried. For example, the image may be a two dimensional image including a number of pixels or a three dimensional image including a number of voxels. The representation generator 516 may generate an image representation comprising symbols based on the image. In some examples, the image representation generator may generate a plurality of image representations representing subsets of voxels in each of three planes. The image representation generator may be a neural network trained to detect one or more features represented by symbols in the image representation. The expression generator 518 may receive a query and generate a target regular expression based on the query. For example, the query may be a fixed query that is predefined. In some examples, the query may be dynamically defined. For example, dynamically defined queries may be used in catalogue systems in which different color patterns may be dynamically defined by different users. The pattern detector 520 may query the image representation for a discrete pattern using the target regular expression.

The image receiver 514, representation generator 516, expression generator 518, and pattern detector may be instructions (e.g., code, logic, etc.) stored in the machine-readable storage device 508 and executed by the processor 504 or other processor to direct the computing device 502 to implement the aforementioned actions. An application-specific integrated circuit (ASIC) may also be employed. In other words, one or more ASICs may be customized for the aforementioned actions implemented via the image receiver 514, representation generator 516, expression generator 518, and pattern detector 520. Further, other graphics processing systems may be used in addition to, or instead of, the systems described above. For example, similar functions may be performed using a pre-programmed floating point gate array (FPGA).

The block diagram of FIG. 5A is not intended to indicate that the computing device 502 is to include all of the components shown in FIG. 5A. Further, the computing device 502 may include any number of additional components not shown in FIG. 5A, depending on the details of the specific implementation.

FIG. 5B is block diagram of another example computing device to query images for discrete patterns using regular expressions. FIG. 5B includes similarly numbered elements of FIG. 5A above. The computing device 502 of FIG. 5B includes an image receiver 514, a representation generator 516, an expression generator 518, and a pattern detector 520.

The block diagram of FIG. 5B is not intended to indicate that the computing device 502 is to include all of the components shown in FIG. 5B. Further, the computing device 502 may include any number of additional components not shown in FIG. 5B, depending on the details of the specific implementation, such as any of the additional components shown in FIG. 5A. For example, the computing device 502 may also include a preprocessor to process the received images prior to being processed by the representation generator 516. The preprocessor may downscale the images and reduce the number of colors in the images. The preprocessor may then send the images to the representation generator 516 for further processing as discussed above.

FIG. 6 is an example machine-readable storage medium that may be used to query images for discrete patterns using regular expressions. The machine-readable medium is generally referred to by the reference number 600. The machine-readable medium 600 can include RAM, a hard disk drive, an array of hard disk drives, an optical drive, an array of optical drives, a non-volatile memory, a flash drive, a digital versatile disk (DVD), or a compact disk (CD), among others. The machine-readable storage medium 600 may be accessed by a processor 602 over a bus 604. The processor 602 may be a processor of a computing device, such as the processor 504 of FIG. 5. The processor 602 may include a field-programmable gate array (FPGA) processor, or an ASIC processor. Furthermore, as indicated, the machine-readable medium 600 may include code configured to perform the methods and techniques described herein. Indeed, the various logic components discussed herein may be stored on the machine-readable medium 600. Portions 606, 608, and 610 of the machine-readable storage medium 600 may include receiver code, locator code, and change detector code, respectively, which may be executable code (machine readable instructions) that direct a processor or controller in performing the techniques discussed with respect to the preceding figures.

Indeed, the various logic (e.g., instructions, code) components discussed herein may be stored on the tangible, non-transitory machine-readable medium 600 as indicated in FIG. 6. For example, the machine-readable medium 600 may include the receiver module code 606 that, when executed by a processor, direct the processor or a computing device to receive an image to be queried. The image may be a two-dimensional image including pixels or a three dimensional image including voxels. The machine-readable medium 600 may also include representation generator module code 608 that when executed by a processor to direct the processor or a computing device to generate an image representation comprising symbols based on the image. The representation generator module code 608 may direct the processor or computing device to generate a lexical quantization based on the received image. The image representation may be generated based on the lexical quantization. Further, multiple image representations may be generated based on the dimensions of the received image. For example, a two-dimensional image may be rotated by 90 degrees to generate a second image representation for the two dimensional image. At least a third image representation may similarly be generated for a three dimensional image containing voxels. The machine-readable medium 600 may further include expression generator code 610 that, when executed by a processor, direct the processor or a computing device to receive a query and generate a target regular expression based on the query. For example, a predefined regular expression library may be used to generate the target regular expression. The machine-readable medium 600 may further include pattern detector module code 612 that, when executed by a processor, direct the processor or computing device to query the image representation for a discrete pattern using the target regular expression. In some examples, region matches may be located in the image representation as offset or index values. A visualization or display of match regions resulting from the query may then be generated. The match regions resulting from the query may be analyzed. For example, the match regions may be queried for additional discrete patterns and a subset of the match regions may be returned. The resulting subset may be a union of two or more types of discrete patterns.

Although shown as contiguous blocks, the logic components may be stored in any order or configuration. For example, if the machine-readable medium 600 is a hard drive, the logic components may be stored in non-contiguous, or even overlapping, sectors. In addition, it is to be understood that any number of additional software components not shown in FIG. 6 may be included within the tangible, non-transitory, computer-readable medium 600, depending on the specific application. For example, the tangible, non-transitory, computer-readable medium 600 may also include a preprocessor module to process the received images prior to being processed by the representation generator 516. The preprocessor module may downscale the images and reduce the number of colors in the images. The preprocessor may then send the images to the representation generator 516 for further processing as discussed above.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method comprising:
receiving an image to be queried;
generating, via a classifier, an image representation comprising symbols based on the image;
receiving a query and generating a target regular expression based on the query; and
querying the image representation for a discrete pattern using the target regular expression.

2. The method of claim 1, wherein generating the image representation comprises generating a lexical quantization based on the image, and generating the image representation based on the lexical quantization.

3. The method of claim 2, comprising rotating the lexical quantization by 90 degrees and generating a second image representation for vertical neighbors based on the rotated lexical quantization, querying the second image representation using the target regular expression, and returning a union of the query of the image representation and the second image representation as a result.

4. The method of claim 1, wherein querying the image representation comprises locating match regions in the image representation as offsets or index values.

5. The method of claim 4, comprising generating a visualization or display of match regions resulting from the query.

6. An apparatus comprising:
an image receiver to receive an image to be queried;
an image representation generator to generate an image representation comprising symbols based on the image;
a query receiver to receive a query and generate a target regular expression based on the query; and
a pattern detector to query the image representation for a discrete pattern using the target regular expression.

7. The apparatus of claim 6, wherein the image comprises a three dimensional image comprising a plurality of voxels, wherein the image representation generator is to generate a plurality of image representations representing subsets of voxels in each of three planes.

8. The apparatus of claim 6, wherein the image representation generator comprises a neural network trained to detect one or more features represented by symbols in the image representation.

9. The apparatus of claim 6, wherein the query comprises a fixed query that is predefined.

10. The apparatus of claim 6, wherein the query is dynamically defined.

11. A non-transitory machine-readable storage medium encoded with instructions executable by a processor, the machine-readable storage medium comprising instructions to:
receive an image to be queried;
generate an image representation comprising symbols based on the image;
receive a query and generate a target regular expression based on the query; and
query the image representation for a discrete pattern using the target regular expression.

12. The non-transitory machine-readable storage medium of claim 11, comprising instructions to generate a lexical quantization based on the received image, wherein the image representation is generated based on the lexical quantization.

13. The non-transitory machine-readable storage medium of claim 11, comprising instructions to locate region matches in the image representation as offset or index values.

14. The non-transitory machine-readable storage medium of claim 11, comprising instructions to generate a visualization or display of match regions resulting from the query.

15. The non-transitory machine-readable storage medium of claim 11, comprising instructions to analyze the match regions resulting from the query.
